(19) United States
(12) Patent Application Publication
(10) Pub. No.: US 2012/0091403 A1
(43) Pub. Date: Apr. 19, 2012

(54) LITHIUM ION RECHARGEABLE BATTERIES & THE ADDITIVE FOR LITHIUM ION RECHARGEABLE BATTERIES WHICH PREVENTS INCREASE OF THE VISCOSITY

(76) Inventors: Yuki OKUDA, Hitachi (JP); Norio Iwayasu, Hitachinaka (JP); Jinbao Zhao, Xiamen (CN); Hidetoshi Honbou, Hitachinaka (JP)

(21) Appl. No.: 13/217,497

(22) Filed: Aug. 25, 2011

(30) Foreign Application Priority Data
Oct. 18, 2010 (JP) 2010-233958

(51) Int. Cl. H01B 1/08; C08B 37/00; C08F 120/44

(52) U.S. Cl. 252/519.15; 526/341; 536/123.12

(57) ABSTRACT

The preparation of a slurry so as to exhibit no strong alkalinity not only needs a strict pH control, but also needs once dispersing a positive electrode material in water and the operation of drying after the treatment, and other operations, thereby leading to the complication of the operations and a decrease in the yield. In consideration of the above-mentioned problems, the present invention provides a method for producing a positive electrode plate for a lithium ion rechargeable battery, which exhibits less complication of the operations and less decrease in the yield and can prevent the gelation of a positive electrode material slurry. The above-mentioned problems can be solved by a positive electrode for a lithium ion rechargeable battery containing a positive electrode active material capable of absorbing/desorbing lithium ions, a nitrile group-containing polymer, and a binder.

### BACKGROUND OF THE INVENTION

1. Field of the Invention

The present invention relates to a positive electrode plate obtained by applying a positive electrode mixture slurry containing a lithium-transition metal composite compound, an electroconductive material, a binder and a solvent onto a current collector, and a lithium ion rechargeable battery having the positive electrode plate.

2. Background Art

A steadily growing interest in energy storage devices has recently been taken. Lithium ion rechargeable batteries, nickel cadmium batteries and nickel hydrogen rechargeable batteries are broadly used as power sources for, for example, mobile information communication terminals including cell phones and laptop computers, and video cameras and portable music playback devices. Particularly lithium ion rechargeable batteries have the superiority in various characteristics such as the high energy density characteristic and the high output density characteristic, have been researched and developed rapidly since their advent, and have established their position as standard batteries for these household devices.

Along with the high functionalization of these mobile information communication terminals, a further improvement in the high energy density characteristic, that is, an enhancement in the capacity, of a lithium ion rechargeable battery (hereinafter, suitably simply referred to as “battery”) as a power source has been demanded.

A lithium ion rechargeable battery is constituted of a positive electrode, a negative electrode, a separator and an electrolytic solution. A positive electrode and a negative electrode each can be obtained, for example, by mixing an active material, an electroconductive material to impart the electroconductivity, and a binder to bind these in a solvent, and applying the mixture onto a current collector. The obtained positive electrode and negative electrode are overlapped through a separator, and wound into a roll shape and inserted in battery can; a nonaqueous solvent (organic solvent) containing an electrolytic salt dissolved therein is injected as an electrolytic solution in the battery can; thereafter, a lid of the battery can is attached through an insulative gasket; and processes such as sealing are carried out to make a battery to be used.

The enhancement of the capacity of a battery can be achieved, for example, by making large the application amounts per unit area of a positive electrode and a negative electrode. However, if the application amount is increased too much, the internal resistance increases and the battery performance is caused to decrease. Additionally, the increase in the application amount causes rupture in an electrode when wound, decreasing the productivity. Therefore, in order to enhance the capacity of a battery, the capacities of a positive electrode and negative electrode active materials themselves essentially need to be enhanced.

For a positive electrode active material, a lithium-transition metal composite oxide is conventionally used, and particularly lithium cobalt dioxide (lithium cobaltate) is often used from the viewpoint of a balance between the battery capacity, the cycle characteristics and the like. However, since the capacity of a positive single electrode chargeable/dischargeable in the potential range of 4.3 V to 3.0 V is as low as about 150 Ah/kg, in order to further enhance the capacity, the material itself needs to be improved.

In a positive electrode active material, a metal such as Ni or Mn may be used in place of Co of lithium cobaltate (LiCoO₂). Lithium nickel dioxide (LiNiO₂) using nickel as the metal, since it provides a capacity of about 200 Ah/kg in the potential range of 4.3 V to 3.0 V, is effective in order to enhance the capacity of a positive electrode.

For a negative electrode material, a compound capable of absorbing/desorbing lithium ions is used. Carbon materials are generally used, including natural graphite as well as flake, massive or other artificial graphite, graphite-based carbon materials such as mesophase pitch-based graphite, and amorphous carbon materials obtained by firing a furan resin or the like obtained from furfuryl alcohol or the like.

A positive electrode plate used in a battery is obtained by kneading a lithium-transition metal composite oxide, an electroconductive material such as a carbon fine particle or a carbon fiber to improve the electroconductivity, a polyvinylidene difluoride to bind these, and the like in N-methyl-2-pyrrolidone as a dispersing solvent to prepare a slurry, and applying the slurry thinly onto a current collector such as an aluminum foil.

In the application step, the viscosity of the slurry is important. In order to acquire a uniform coating thickness, the control of the slurry viscosity, particularly the prevention of the increase in the viscosity and the gelation of the slurry is demanded. A positive electrode active material including a lithium-nickel composite oxide has much of carbonates such as Li₂CO₃ present on the surface layer of the active material, and the three-dimensionalization of a binder proceeds by an alkali produced by the reaction of the carbonates and water. If a slurry is prepared using such a positive electrode active material, a problem that arises is that the slurry loses the fluidity and increases the viscosity and gelates. If a slurry loses the fluidity, not only it makes it difficult to acquire a uniform coating thickness, but also it does not allow the slurry to be applied and leads to generation of waste of the materials in some cases. There remarkably arises this problem particularly in a nickel-lithium-transition metal composite oxide because the composite oxide has Li₂CO₃ easily present on the surface layer.

For example, JP Patent Publication (Kokai) No. 2000-90917A discloses a technique of preparing a slurry so as to exhibit no strong alkalinity even if being dispersed in water to prevent the gelation of the slurry.

### SUMMARY OF THE INVENTION

However, as in the invention described in the JP Patent Publication (Kokai) No. 2000-90917A, the preparation of a slurry so as to exhibit no strong alkalinity not only needs a strict pH control, but also needs once dispersing a positive electrode material in water and an operation of drying after the treatment, and other operations, thereby leading to the complication of the operations and a decrease in the yield. Therefore, the present invention has an object to prevent an increase in the viscosity and the gelation of a positive electrode mixture slurry, thereby simplifying the operations and preventing a decrease in the yield.

As a result of exhaustive studies in order to achieve the above-mentioned object, the present inventors have found that the addition of a nitrile group-containing polymer in preparation of a positive electrode mixture slurry can prevent the increase in the viscosity and the gelation of the positive electrode mixture slurry.

That is, the present invention includes the following.

(1) A positive electrode for a lithium ion rechargeable battery, comprising:

a positive electrode active material capable of absorbing/desorbing lithium ions;

a nitrile group-containing polymer; and

a binder,

wherein the positive electrode comprises 0.001 to 0.5 parts by weight of the nitrile group-containing polymer with respect to 100 parts by weight of the positive electrode active material.

(2) The positive electrode for a lithium ion rechargeable battery according to (1), wherein the positive electrode comprises 0.01 to 0.4 parts by weight of the nitrile group-containing polymer with respect to 100 parts by weight of the positive electrode active material.

(3) The positive electrode for a lithium ion rechargeable battery according to (1) or (2), wherein the nitrile group-containing polymer has a constitutional unit represented by the general formula (I):

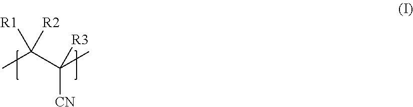

[wherein, R1 to R3 are each independently hydrogen, C₁ to C₆ alkyl, C₁ to C₆ alkoxy, C₃ to C₆ cycloalkyl, or COOR (R is hydrogen or C₁ to C₆ alkyl)].

(4) The positive electrode for a lithium ion rechargeable battery according to (1) or (2), wherein the nitrile group-containing polymer is a cyanoethylated polysaccharide.

(5) The positive electrode for a lithium ion rechargeable battery according to (4), wherein the cyanoethylated polysaccharide is at least one selected from the group consisting of cyanoethylpullulan, cyanoethylcellulose, cyanoethylsucrose and cyanoethylsaccharose.

(6) The positive electrode for a lithium ion rechargeable battery according to any of (1) to (5), wherein the positive electrode active material is a lithium-nickel-containing composite oxide.

(7) The positive electrode for a lithium ion rechargeable battery according to (6), wherein the lithium-nickel-containing composite oxide is represented by the composition formula:

LiₓNi_{(1-y)}M_{y}O₂

[wherein, x is in the range of 0≦x≦1.2, and y is in the range of 0≦y<0.5; and M is at least one selected from the group consisting of Al, Mg, Mn, Fe, Co, Cu, Zn, Ti, Ge, W and Zr].

(8) The positive electrode for a lithium ion rechargeable battery according to (6) or (7), wherein the lithium-nickel-containing composite oxide comprises at least one selected from the group consisting of A₂CO₃ and AOH (A is an alkaline metal) on a surface layer thereof.

(9) The positive electrode for a lithium ion rechargeable battery according to any of (1) to (8), wherein the positive electrode comprises 0.5 to 5 parts by weight of the binder with respect to 100 parts by weight of the positive electrode active material.

(10) A lithium ion rechargeable battery, comprising a positive electrode for a lithium ion rechargeable battery according to any of (1) to (9).

(11) A method for producing a positive electrode for a lithium ion rechargeable battery, comprising mixing:

a positive electrode active material capable of absorbing/desorbing lithium ions;

a nitrile group-containing polymer;

a binder; and

an organic solvent, to prepare a positive electrode mixture slurry,

wherein 0.001 to 0.5 parts by weight of the nitrile group-containing polymer is mixed with respect to 100 parts by weight of the positive electrode active material.

(12) A method for preventing an increase in the viscosity of a positive electrode mixture slurry for a lithium ion rechargeable battery, comprising mixing:

a positive electrode active material capable of absorbing/desorbing lithium ions;

a nitrile group-containing polymer;

a binder; and

an organic solvent,

wherein 0.001 to 0.5 parts by weight of the nitrile group-containing polymer is mixed with respect to 100 parts by weight of the positive electrode active material.

(13) An additive for preventing an increase in the viscosity of a positive electrode mixture slurry for a lithium ion rechargeable battery, comprising a nitrile group-containing polymer, wherein 0.001 to 0.5 parts by weight of the nitrile group-containing polymer is to be mixed with respect to 100 parts by weight of a positive electrode active material.

### EFFECT OF THE INVENTION

The present invention can prevent inexpensively an increase in the viscosity and the gelation of a positive electrode mixture slurry, and can thereby simplify the fabrication of a battery and prevent a decrease in the yield.

This description includes part or all of the contents as disclosed in the description and/or drawings of Japanese Patent Application No. 2010-233958, which is a priority document of the present application.

### BRIEF DESCRIPTION OF THE DRAWING

FIG. 1 is a diagram of measurement results of viscosities of Examples 1 and 2 and Comparative Example 2 using a rotational viscometer.

### DETAILED DESCRIPTION OF THE EMBODIMENTS

Hereinafter, the present invention will be described in detail.

### 1. Positive Electrode for a Lithium Ion Rechargeable Battery

The positive electrode for a lithium ion rechargeable battery according to the present invention comprises a positive electrode active material capable of absorbing/desorbing lithium ions, a nitrile group-containing polymer, and a binder.

### (1) Positive Electrode Active Material

A positive electrode active material used in the present invention is not especially limited as long as being a material capable of absorbing/desorbing lithium ions. However, much of carbonates such as Li₂CO₃ being a cause of the increase in the viscosity of a positive electrode mixture slurry, which is a problem intended to be solved by the present invention, is present on the surface layer of a lithium-nickel-containing composite oxide. Therefore, the present invention is especially effective in the case of using a lithium-nickel-containing composite oxide as a positive electrode active material.

The lithium-nickel-containing composite oxide refers to a metal oxide containing at least a lithium element and a nickel element as metal elements, and examples thereof include lithium-nickel composite oxides, which contain Li and Ni as in LiNiO₂, and lithium-nickel-containing composite oxides, which contain, in addition to Li and Ni, at least one transition metal denoted as M as in LiₓNi_{(1-y)}M_{y}O₂ (x is 0≦x≦1.2, and y is 0≦y<0.5; and M is at least one metal element selected from the group consisting of Al, Mg, Mn, Fe, Co, Cu, Zn, Ti, Ge, W and Zr, and preferably at least one metal element selected from the group consisting of Mn, Co and Al). The positive electrode active material may contain, on the surface layer, at least one carbonate and/or hydroxide selected from the group consisting of A₂CO₃ and AOH (A is an alkaline metal), for example, Li₂CO₃ and LiOH.

Also another compound, capable of absorbing/desorbing lithium ions and exhibiting a pH of 9 to 12 when the pH of a supernatant is measured after a dispersion liquid in which the positive electrode active material has been dispersed and stirred in water is left to stand for 30 min, can be expected to have the similar effect. Examples of such a compound include lithium-containing composite oxides represented by LiₓMO₂ or Li_{y}M₂O₄ (x is 0≦x≦1, and y is 0≦y≦2; and M is at least one metal element selected from the group consisting of Al, Mg, Mn, Fe, Co, Cu, Zn, Ti, Ge, W and Zr), spinel-type oxides, metal chalcogenides having a layer structure, and olivine structures. Specific examples thereof include lithium cobalt oxides such as LiCoO₂, lithium manganese oxides such as LiMn₂O₄, lithium titanium oxides such as Li_{4/3}Ti_{5/3}O₄, metal oxides such as manganese dioxide, vanadium pentoxide and chromium oxide, materials having an olivine-type crystal structure such as LiMPO₄ (M=Fe, Mn, Ni), and metal sulfides such as titanium disulfide and molybdenum disulfide.

These positive electrode active materials may be used singly or as a mixture of two or more.

### (2) Nitrile Group-Containing Polymer

A nitrile group-containing polymer in the present invention is used in order to prevent the increase in the viscosity and the gelation of a positive electrode mixture slurry. The nitrile group-containing polymer is not especially limited as long as being a polymer having a nitrile group in the molecular structure. Examples thereof include homopolymers and copolymers having a constitutional unit represented by the general formula (I):

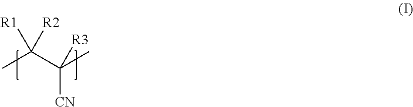

(wherein, R1 to R3 are each independently hydrogen, C₁ to C₆ alkyl, C₁ to C₆ alkoxy, C₃ to C₆ cycloalkyl, or COOR (R is hydrogen or C₁ to C₆ alkyl), and preferably hydrogen or C₁ to C₄ alkyl (methyl, ethyl, n-propyl, i-propyl, s-butyl, t-butyl or the like)), and cyanoethyl compounds obtained by substituting polyvinyl alcohols, polysaccharides or derivatives thereof with a cyanoethyl group.

Examples of the homopolymers and copolymers having a constitutional unit represented by the general formula (I) include acrylic polymers such as polyacrylonitrile, polymethacrylonitrile and copolymers of acrylonitrile and methacrylonitrile, and cyanoacrylate polymers such as polycyanoacrylate. From the viewpoint of the easiness of material procurement and a preventive effect on the increase in the viscosity, particularly homopolymers and copolymers of acrylonitrile and methacrylonitrile are preferable, and polyacrylonitrile is more preferable.

Examples of the cyanoethyl compounds include cyanoethylated polyvinyl alcohols, and cyanoethylated polysaccharides such as cyanoethylcellulose, cyanoethylpullulan, cyanoethylsucrose and cyanoethylsaccharose. These cyanoethyl compounds can be obtained by substituting raw materials with a cyanoethyl group. The raw materials are preferable which have a substitutional rate of a hydroxyl group of 50% or more, and more preferable which have a substitutional rate thereof of 80% or more.

The nitrile group-containing polymers may be used singly or as a mixture of two or more.

If the content of a nitrile group-containing polymer is more than 0.5 parts by weight with respect to 100 parts by weight of a positive electrode active material, since gases are generated when the battery temperature becomes high or when a battery is exposed to a high-temperature atmosphere, deformation of the battery and exfoliation of an electrode layer are caused, which is thus likely to invite a decrease in battery performance. Therefore, a nitrile group-containing polymer is contained especially preferably in 0.001 to 0.5 parts by weight, more preferably in 0.01 to 0.4 parts by weight, and most preferably in 0.05 to 0.2 parts by weight, with respect to 100 parts by weight of a positive electrode active material.

The presence of a nitrile group-containing polymer in a produced positive electrode and battery can be confirmed, for example, by a time-of-flight secondary ion mass spectrometer (TOF-SIMS). The content of a nitrile group-containing polymer can be measured, for example, by X-ray photoelectron spectroscopy (XPS) surface analysis. For example, in the case of using a polyacrylonitrile as a nitrile group-containing polymer, the measurement of a C1s spectrum of an electrode layer enables to observe a peak due to a —CN bond near 287 eV and peaks due to carbon in the electrode and hydrogen in the polymer (C, C—C, C—H) near 285 eV. Peaks due to lithium carbonate can further be observed near 289 to 290 eV. Therefore, comparison of magnitudes of these peaks allows for measurement of the content of a nitrile group-containing polymer.

The weight-average molecular weight of the polymer can be measured, for example, using gel permeation chromatography. The weight-average molecular weight of the polymer is not especially limited as long as being in the range of 1,000 to 1,000,000, but is preferably 10,000 to 500,000, and more preferably 50,000 to 200,000.

A method for synthesizing a nitrile group-containing polymer used in the present invention is not especially limited, and any method of conventionally known bulk polymerization, solution polymerization and emulsion polymerization may be used. The solution polymerization is especially preferable. A polymerization method is not especially limited, and radical polymerization is suitably used. A polymerization initiator may or may not be used in polymerization, and a radical polymerization initiator is preferably used from the viewpoint of easiness of handleability. A polymerization method using a radical polymerization initiator can be carried out in the commonly used temperature range and polymerization time. For the purpose of not damaging members used in electrochemical devices, a radical polymerization initiator is preferably used in which the 10-hour half-life temperature range as an index of the decomposition temperature and rate is 30 to 90° C. The 10-hour half-life temperature refers to a necessary temperature at which the amount of the undecomposed radical polymerization initiator of 0.01 mol/L in concentration in a radical-inert solvent such as benzene decreases to a half in 10 hours.

The blending amount of a polymerization initiator in the present invention is usually 0.1 to 5 parts by weight, and preferably 0.3 to 2 parts by weight, with respect to 100 parts by weight of a polymerizable compound. Examples of the radical polymerization initiators include organic peroxides such as t-butyl peroxypivalate, t-hexyl peroxypivalate, methyl ethyl ketone peroxide, cyclohexanone peroxide, 1,1-bis(t-butylperoxy)-3,3,5-trimethylcyclohexane, 2,2-bis(t-butylperoxy)octane, N-butyl-4,4-bis(t-butylperoxy)valerate, t-butyl hydroperoxide, cumene hydroperoxide, 2,5-dimethylhexane-2,5-dihydroperoxide, di-t-butyl peroxide, t-butyl cumyl peroxide, dicumyl peroxide, α,α′-bis(t-butylperoxy-m-isopropyl)benzene, 2,5-dimethyl-2,5-di(t-butylperoxy)hexane, 2,5-dimethyl-2,5-di(t-butylperoxy)hexane, benzoyl peroxide and t-butylperoxypropyl carbonate, and azo compounds such as 2,2′-azobis[2-(2-imidazolin-2-yl)propane], 2,2′-azobis{2-methyl-N-[1,1-bis(hydroxymethyl)-2-hydroxyethyl]propionamide}, 2,2′-azobis{2-methyl-N-[1,1-bis(hydroxymethyl)ethyl]propionamide}, 2,2′-azobis[2-methyl-N-(2-hydroxyethyl)propionamide], 2,2′-azobis(2-methylpropionamide)dihydrate, 2,2′-azobis(2,4,4-trimethylpentane), 2,2′-azobis(2-methylpropane), dimethyl 2,2′-azobisisobutyrate, 4,4′-azobis(4-cyanovaleric acid), 2,2′-azobis[2-(hydroxymethyl)propionitrile] and azobisisobutyronitrile.

### (3) Binder

A binder in the present invention is not especially limited, and binders commonly used in lithium ion rechargeable batteries can be used. Examples thereof include polyethylene, polypropylene, polytetrafluoroethylene (PTFE), polyvinylidene difluoride (PVDF), polyhexafluoropropylene (PHFP), styrene-butadiene rubber, tetrafluoroethylene-hexafluoro ethylene copolymers, tetrafluoroethylene-hexafluoropropylene copolymers (FEP), tetrafluoroethylene-perfluoroalkyl vinyl ether copolymers (PFA), vinylidene fluoride-hexafluoropropylene copolymers, vinylidene fluoride-chlorotrifluoroethylene copolymers, ethylene-tetrafluoroethylene copolymers (ETFE resins), polychlorotrifluoroethylene (PCTFE), vinylidene fluoride-pentafluoropropylene copolymers, propylene-tetrafluoroethylene copolymers, ethylene-chlorotrifluoroethylene copolymers (ECTFE), vinylidene fluoride-hexafluoropropylene-tetrafluoroethylene copolymers, vinylidene fluoride-perfluoromethyl vinyl ether-tetrafluoro ethylene copolymers, ethylene-acrylic acid copolymers, ethylene-methacrylic acid copolymers, ethylene-methyl acrylate copolymers and ethylene-methyl methacrylate copolymers, and polyvinylidene difluoride is preferably used.

The amount of a binder is not especially limited, and is preferably 0.5 to 5 parts by weight, and especially preferably 1 to 5 parts by weight, with respect to 100 parts by weight of a positive electrode active material.

### (4) Electroconductive Material

For the purpose of improving the electroconductivity of a positive electrode mixture layer, an electroconductive material may be contained in a positive electrode mixture. Examples of the electroconductive materials include carbon fine particles and carbon fibers, and specifically include carbon fine particles such as carbon black, acetylene black, channel black, thermal black, carbon nanotubes and carbon nanohorns. The electroconductive materials are not limited to these materials as long as achieving the purpose of imparting the electroconductivity.

### (5) Organic Solvent

An organic solvent used for preparation of a positive electrode mixture slurry is not especially limited as long as being capable of preparing a slurry and being capable of dissolving a nitrile group-containing polymer. Examples thereof include amides such as N-methyl-2-pyrrolidone, N,N-dimethylacetamide and N,N-dimethylformamide, ureas such as N,N-dimethylethylene urea, N,N-dimethylpropylene urea and tetramethylurea, lactones such as γ-butyrolactone and γ-caprolactone, carbonates such as propylene carbonate, ketones such as methyl ethyl ketone, methyl isobutyl ketone and cyclohexanone, esters such as ethyl acetate, n-butyl acetate, butyl cellosolve acetate, butyl carbitol acetate, ethyl cellosolve acetate and ethyl carbitol acetate, glymes such as diglymes, triglymes and tetraglymes, hydrocarbons such as toluene, xylene and cyclohexane, and sulfones such as sulfolane. Among these, amides are preferable and N-methyl-2-pyrrolidone, N,N-dimethylacetamide and N-methyl-2-pyrrolidone are especially preferable, from the viewpoint of excellent solubility of the binder resin. These solvents may be used singly or as a mixture of two or more. The organic solvent is dried and removed after the slurry is applied on a current collector.

### (6) Method for Preparing a Positive Electrode Mixture Slurry

A method for preparing a slurry in the present invention is not especially limited as long as the slurry capable of being applied on a current collector by an optional facility and means can be prepared, and the slurry can be prepared by any method.

A nitrile group-containing polymer may be used which has been previously dissolved in an organic solvent, or may be added during the slurry preparation. A solvent to dissolve a nitrile group-containing polymer is not especially limited, and the above-mentioned organic solvents can be used.

A slurry can be prepared, for example, by procedures:

(i) a positive electrode active material and an electroconductive material are mixed and dispersed in a solvent;
(ii) to the mixture obtained in (i), a nitrile group-containing polymer which has been previously dissolved in a solvent is added; and
(iii) a binder is further added, and as required, a solvent is added to regulate the viscosity.

### 2. Lithium Ion Rechargeable Battery

The lithium ion rechargeable battery according to the present invention comprises the above-mentioned positive electrode for a lithium ion rechargeable battery, a negative electrode containing an active material capable of absorbing/desorbing lithium ions, and an electrolytic solution.

### (1) Negative Electrode for a Lithium Ion Rechargeable Battery

For the negative electrode for a lithium ion rechargeable battery according to the present invention, a compound capable of absorbing/desorbing lithium ions can be used, and used are natural graphite, flake, massive or other artificial graphite, materials obtained by subjecting easily-graphitizable materials obtained from petroleum coke, coal pitch coke or the like to a thermal treatment at a temperature of 2,500° C. or higher, mesophase pitch-based graphite, amorphous carbons obtained by firing a furan resin or the like from furfuryl alcohol or the like, carbon fibers, metals alloying with lithium, and materials in which a metal is carried on the carbon particle surface. The metal to be used is for example, a metal selected from the group consisting of lithium, silver, aluminum, tin, silicon, indium, gallium and magnesium, or an alloy thereof. The metal or an oxide of the metal may be used as a negative electrode active material. Lithium titanate may be used.

### (2) Electrolytic Solution

An electrolytic solution is prepared by dissolving an electrolyte salt such as a lithium salt in a nonaqueous solvent such as an organic solvent. Examples of the nonaqueous solvent include carbonates such as propylene carbonate, ethylene carbonate, dimethyl carbonate, diethyl carbonate and ethyl methyl carbonate, and tetrahydrofuran, 2-methyltetrahydrofuran, γ-butyrolactone, and 1,2-dimethoxyethane.

As an electrolyte salt used for a nonaqueous electrolytic solution, suitably usable are lithium salts such as perchlorate salts of lithium, organoboron lithium salts, lithium salts of fluorine-containing compounds and lithium imide salts. Specific examples of such electrolyte salts include LiClO₄, LiPF₆, LiBF₄, LiAsF₆, LiSbF₆, LiCF₃SO₃, LiCF₃CO₂, Li₂C₂F₄(SO₃)₂, LiN(CF₃SO₂)₂, LiN(C₂F₅SO₂)₂, LiC (CF₃SO₂)₃, LiCNF_{2N+1}SO₃ (N≧2) and LiN(RfOSO₂)₂ [wherein Rf is a fluoroalkyl group]. Among these lithium salts, fluorine-containing organolithium salts can suitably be used.

The concentration of an electrolyte salt in a nonaqueous electrolytic solution is, for example, preferably 0.3 mol/L or more, more preferably 0.7 mol/L or more, and preferably 1.7 mol/L or less, and more preferably 1.2 mol/L or less. Too low an electrolyte salt concentration lessens the ionic conductivity in some cases; and too high one has a risk of deposition of the undissolved electrolyte salt.

To a nonaqueous electrolytic solution in the present invention, various types of additives to improve the battery performance may be added. For example, in a nonaqueous electrolytic solution to which a compound having a C═C unsaturated bond in the molecule is added, the decrease in charge/discharge cycle characteristics of a battery can be prevented in some cases. Examples of a compound having a C═C unsaturated bond in the molecule include aromatic compounds such as C₆H₅C₆H₁₁ (phenylcyclohexane), fluorinated aliphatic compounds such as H(CF₂)₄CH₂OOCCH═CH₂ and F(CF₂)₈CH₂CH₂OOCCH═CH₂ and fluorine-containing aromatic compounds. Additionally, compounds having a sulfur element including 1,3-propanesultone and 1,2-propanediol sulfate (for example, a chain or cyclic sulfonate ester, and a chain or cyclic sulfate), vinylene carbonate, vinyl ethylene carbonate, fluorinated ethylene carbonate, and the like can be used. The addition amount of these various types of additives is, for example, preferably 0.05 to 5 parts by weight in the total amount of a nonaqueous electrolytic solution.

### 3. Method for Producing a Positive Electrode for a Lithium Ion Rechargeable Battery

The present invention includes a method for producing a positive electrode for a lithium ion rechargeable battery. The production method comprises a step of mixing a positive electrode active material capable of absorbing/desorbing lithium ions, a nitrile group-containing polymer, a binder and an organic solvent to prepare a positive electrode mixture slurry. For materials including a positive electrode active material, a nitrile group-containing polymer, a binder and an organic solvent, which are used for preparation of a positive electrode mixture slurry, the above-mentioned materials can be used. The present invention further includes a method for producing a lithium ion rechargeable battery using the positive electrode for a lithium ion rechargeable battery produced by the above-mentioned production method.

The addition of a nitrile group-containing polymer to a positive electrode mixture slurry can prevent the increase in the viscosity and the gelation of the slurry. If the addition amount of a nitrile group-containing polymer is more than 0.5 parts by weight, since gases are generated when the battery temperature becomes high or when a battery is exposed to a high-temperature atmosphere, deformation of the battery and exfoliation of an electrode layer are caused, which is thus likely to invite a decrease in battery performance. Therefore, the nitrile group-containing polymer is added preferably in 0.001 to 0.5 parts by weight, more preferably in 0.01 to 0.4 parts by weight, and most preferably in 0.05 to 0.2 parts by weight, with respect to 100 parts by weight of a positive electrode active material.

### 4. Method for Preventing an Increase in the Viscosity of a Positive Electrode Mixture Slurry

The present invention includes a method for preventing an increase in the viscosity of a positive electrode mixture slurry. Although the increase in the viscosity of the slurry is caused by carbonate salts and hydroxides present on the surface layer of the positive electrode active material, by mixing a nitrile group-containing polymer described above in a slurry, the increase in the viscosity can be prevented. The increase in the viscosity of a slurry includes gelation of the slurry.

A method for mixing a nitrile group-containing polymer is not especially limited, and by an optional method and in an optional order, the nitrile group-containing polymer can be mixed with a positive electrode active material, a binder, an organic solvent and the like, which are constituting components of a positive electrode mixture slurry.

### 5. Additive for Preventing the Increase in the Viscosity

The present invention includes an additive for preventing the increase in the viscosity of a positive electrode mixture slurry. An additive for preventing the increase in the viscosity contains a nitrile group-containing polymer described above, and can prevent the increase in the viscosity and the gelation of the slurry. The additive for preventing the increase in the viscosity may contain other optional components, and for example, may contain an organic solvent described above used when the slurry is prepared.

Hitherto, the present invention has been described in detail. Other constituting elements not described hitherto are not especially limited, and the similar constituting elements as in conventionally known nonaqueous electrolyte rechargeable batteries can be employed.

### EXAMPLES

Embodiments according to the present invention will be described hereinafter together with Examples, but the present invention is not limited to the following contents, and optional changes and modifications may be made without departing from the gist.

### <Slurry Preparation Method 1>

In Examples and Comparative Examples in which a nitrile group-containing polymer was added, a solution in which the nitrile group-containing polymer was dissolved in N-methyl-2-pyrrolidone solvent so as to have an optional concentration was previously prepared and used.

100 g of a lithium-nickel-cobalt-aluminum composite oxide as a positive electrode active material and 3 g of acetylene black as an electroconductive material to impart the electroconductivity were mixed; and 10 g of the nitrile group-containing polymer solution described above was added and 63 g of N-methylpyrrolidone was then added thereto, and mixed.

Thereafter, 3 g of polyvinylidene difluoride as a binder was added and further mixed to prepare a slurry for coating an electrode. 10 g of the lithium-nickel-cobalt-aluminum composite oxide used as a positive electrode active material was dispersed in 50 g of water, and stirred for 30 sec, and then left to stand for 30 min; and the resultant supernatant had a pH of 11.

### <Slurry Preparation Method 2>

In Comparative Examples in which no nitrile group-containing polymer was added, a slurry was prepared by the following procedure.

100 g of a lithium-nickel-cobalt-aluminum composite oxide as a positive electrode active material and 3 g of acetylene black as an electroconductive material to impart the electroconductivity were mixed; and 72.9 g of N-methylpyrrolidone was then added, and mixed. Thereafter, 3 g of polyvinylidene difluoride as a binder was added and further mixed to prepare a slurry for coating an electrode. 10 g of the lithium-nickel-cobalt-aluminum composite oxide used as a positive electrode active material was dispersed in 50 g of water, and stirred for 30 sec, and then left to stand for 30 min; and the resultant supernatant had a pH of 11.

### <Production Method of Positive Electrodes>

The slurry prepared in slurry preparation method 1 or 2 was applied on an aluminum foil of 20 μm in thickness by a doctor blade method, and dried. The mixture application amount was 200 g/m². Thereafter, the resultant foil was pressed to produce a positive electrode.

### <Production Method of Negative Electrodes>

Graphite and acetylene black were mixed in a proportion of 90:10% by weight, and dispersed in N-methyl-2-pyrrolidone added thereto to prepare a slurry. The slurry was applied on a copper foil of 20 μm in thickness by a doctor blade method, and dried. The resultant foil was pressed so as to have a mixture bulk density of 1.0 g/cm³, to thus produce a negative electrode.

### <Measurement of the Viscosities>

After the slurries prepared by slurry preparation methods 1 and 2 were left to stand for 2 hours after the preparation, the viscosities were measured using a rotational viscometer; and changes in viscosities during the measurement and the viscosities when exhibiting no change and being in a stationary state were recorded.

### <Observation of the Progresses>

20 g of the each slurry prepared by slurry preparation methods 1 and 2 was put in a small bottle, which was then hermetically sealed, and left to stand at room temperature of 25° C. to visually observe the progress.

### <Evaluation of Square Batteries>

Square batteries were fabricated using the above-mentioned positive electrode and negative electrode. The size of the square batteries was 43 mm long, 34 mm wide and 4.6 mm thick. A cycle in which the fabricated battery was charged to 4.2 V and thereafter discharged to 2.5 V was repeated three times; and thereafter, the battery was charged to 4.2 V, and then put in a thermostat bath at 85° C. and kept for 24 hours. Thereafter, the battery was cooled to room temperature, and the thickness of the battery was measured. The thickness of the battery was measured at the central point of the battery; and by determining the thicknesses of the battery before and after the heating, the swelling of the battery was determined.

### Example 1

In the present Example, a polyacrylonitrile was used as a nitrile group-containing polymer, and a slurry was prepared according to preparation method 1. The weight-average molecular weight of the polymer was measured using gel permeation chromatography. An N-methyl-2-pyrrolidone solution prepared so as to contain a concentration of sodium chloride as a relaxation agent of 0.1 mol/L was used as an eluent; and the weight-average molecular weight calculated in terms of polystyrene from a calibration curve fabricated using standard polystyrenes was 150,000. The nitrile group-containing polymer solution was regulated so that the concentration of the nitrile group-containing polymer was 1% by weight. Therefore, the addition amount of the nitrile group-containing polymer became 0.1 parts by weight with respect to 100 parts by weight of a positive electrode active material.

### Example 2

In the present Example, a slurry for coating an electrode was prepared as in Example 1, except for using a cyanoethylated pullulan (CR-S, made by Shin-Etsu Chemical Co., Ltd.) as a nitrile group-containing polymer. The addition amount of the nitrile group-containing polymer was 0.1 parts by weight with respect to 100 parts by weight of a positive electrode active material, similarly to Example 1.

### Example 3

In the present Example, a positive electrode was produced using the slurry prepared in Example 1, and a square battery was fabricated using the positive electrode.

### Example 4

In the present Example, a polyacrylonitrile was used as a nitrile group-containing polymer, and a slurry was prepared according to preparation method 1. The concentration of the nitrile group-containing polymer was regulated so that the addition amount of the nitrile group-containing polymer was 0.5 parts by weight with respect to 100 parts by weight of a positive electrode active material. A positive electrode was produced using the slurry, and a square battery was fabricated using the positive electrode.

### Comparative Example 1

In the present Comparative Example, a polyacrylonitrile was used as a nitrile group-containing polymer, and a slurry was prepared according to preparation method 1. The concentration of the nitrile group-containing polymer was regulated so that the addition amount of the nitrile group-containing polymer was 5 parts by weight with respect to 100 parts by weight of a positive electrode active material. A positive electrode was produced using the slurry, and a square battery was fabricated using the positive electrode.

### Comparative Example 2

In the present Comparative Example, a slurry for coating an electrode was prepared with no nitrile group-containing polymer added according to preparation method 2.100 g of a lithium-nickel-cobalt-aluminum composite oxide as a positive electrode active material and 3 g of acetylene black as an electroconductive material to impart the electroconductivity were mixed; and 72.9 g of N-methylpyrrolidone was then added, and mixed. Thereafter, 3 g of a polyvinylidene difluoride as a binder was added and further mixed to prepare a slurry for coating an electrode.

### Comparative Example 3

In the present Comparative Example, a positive electrode was produced using the slurry prepared in Comparative Example 2, and a square battery was fabricated using the positive electrode.

### Measurement of the Viscosities

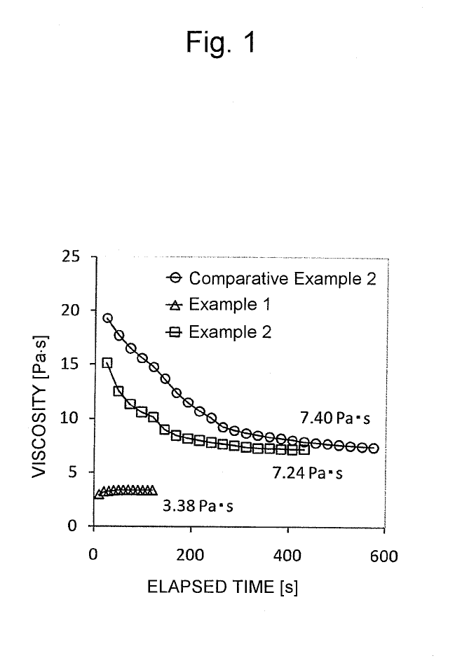

The viscosity measurement results of Example 1, Example 2 and Comparative Example 2 are shown in FIG. 1. From the results, it is found that Example 1 and Example 2 had lower viscosities of the slurries than that of Comparative Example 2, and that the increase in the viscosities was prevented.

### Observation of the Progresses

The changes in fluidity of Example 1, Example 2 and Comparative Example 2 are collectively shown in Table 1. Comparative Example 2 lost the fluidity of the slurry after the elapse of 3 days; by contrast Example 1 and Example 2 kept the fluidity of the slurries for several days thereafter. The period during which the fluidity was kept was longer in Example 1 and Example 2 than in Comparative Example 2, from which it can be confirmed that the addition of a nitrile group-containing polymer had a preventive effect on the increase in the viscosity.

TABLE 1

| | Day 1 | Day 3 | Day 6 | Day 9 |
|---|---|---|---|---|
| Comparative Example 2 | ∘ | ▴ | x | x |
| Example 1 | ∘ | ∘ | ▴ | ▴ |
| Example 2 | ∘ | ∘ | ▴ | x |

Fluidity of Slurry
∘ Good
▴ Yes
x Gelation

### Evaluations of the Square Batteries

The square battery evaluation results of Example 3, Example 4, Comparative Example 1 and Comparative Example 3 are collectively shown in Table 2. Comparative Example 1 exhibited larger swelling than Example 3, Example 4, Comparative Example 3, and deformation of the battery was caused due to gas generation in a state excessive in a nitrile group-containing polymer, which is found to be not preferable.

TABLE 2

| | Polymer Amount | Swelling |
|---|---|---|
| | (parts by weight) | of Battery |
| Comparative Example 3 | No | 3.01 mm |
| Example 3 | 0.1 | 3.11 mm |
| Example 4 | 0.5 | 3.16 mm |
| Comparative Example 1 | 5 | 4.10 mm |

All publications, patents, and patent applications cited herein are incorporated herein by reference in their entirety.

What is claimed is:

1. A positive electrode for a lithium ion rechargeable battery, comprising:
a positive electrode active material capable of absorbing/desorbing lithium ions;
a nitrile group-containing polymer; and
a binder,
wherein the positive electrode comprises 0.001 to 0.5 parts by weight of the nitrile group-containing polymer with respect to 100 parts by weight of the positive electrode active material.

2. The positive electrode for a lithium ion rechargeable battery according to claim 1, wherein the positive electrode comprises 0.01 to 0.4 parts by weight of the nitrile group-containing polymer with respect to 100 parts by weight of the positive electrode active material.

3. The positive electrode for a lithium ion rechargeable battery according to claim 1, wherein the nitrile group-containing polymer has a constitutional unit represented by the general formula (I): 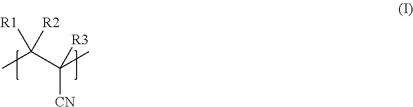
[wherein, R1 to R3 are each independently hydrogen, C₁ to C₆ alkyl, C₁ to C₆ alkoxy, C₃ to C₆ cycloalkyl, or COOR (R is hydrogen or C₁ to C₆ alkyl)].

4. The positive electrode for a lithium ion rechargeable battery according to claim 1, wherein the nitrile group-containing polymer is a cyanoethylated polysaccharide.

5. The positive electrode for a lithium ion rechargeable battery according to claim 4, wherein the cyanoethylated polysaccharide is at least one selected from the group consisting of cyanoethylpullulan, cyanoethylcellulose, cyanoethylsucrose and cyanoethylsaccharose.

6. The positive electrode for a lithium ion rechargeable battery according to claim 1, wherein the positive electrode active material is a lithium-nickel-containing composite oxide.

7. The positive electrode for a lithium ion rechargeable battery according to claim 6, wherein the lithium-nickel-containing composite oxide is represented by the composition formula:
LiₓNi_{(1-y)}M_{y}O₂
[wherein, x is in the range of 0≦x≦1.2, and y is in the range of 0≦y<0.5; and M is at least one selected from the group consisting of Al, Mg, Mn, Fe, Co, Cu, Zn, Ti, Ge, W and Zr].

8. The positive electrode for a lithium ion rechargeable battery according to claim 6, wherein the lithium-nickel-containing composite oxide comprises at least one selected from the group consisting of A₂CO₃ and AOH (A is an alkaline metal) on a surface layer thereof.

9. The positive electrode for a lithium ion rechargeable battery according to claim 1, wherein the positive electrode comprises 0.5 to 5 parts by weight of the binder with respect to 100 parts by weight of the positive electrode active material.

10. A lithium ion rechargeable battery, comprising a positive electrode for a lithium ion rechargeable battery according to claim 1.

11. A method for producing a positive electrode for a lithium ion rechargeable battery, comprising mixing:
a positive electrode active material capable of absorbing/desorbing lithium ions;
a nitrile group-containing polymer;
a binder; and
an organic solvent, to prepare a positive electrode mixture slurry,
wherein 0.001 to 0.5 parts by weight of the nitrile group-containing polymer is mixed with respect to 100 parts by weight of the positive electrode active material.

12. A method for preventing an increase in the viscosity of a positive electrode mixture slurry for a lithium ion rechargeable battery, comprising mixing:
a positive electrode active material capable of absorbing/desorbing lithium ions;
a nitrile group-containing polymer;
a binder; and
an organic solvent,
wherein 0.001 to 0.5 parts by weight of the nitrile group-containing polymer is mixed with respect to 100 parts by weight of the positive electrode active material.

13. An additive for preventing an increase in the viscosity of a positive electrode mixture slurry for a lithium ion rechargeable battery, comprising a nitrile group-containing polymer, wherein 0.001 to 0.5 parts by weight of the nitrile group-containing polymer is to be mixed with respect to 100 parts by weight of a positive electrode active material.
